(19) United States
(12) Patent Application Publication
(10) Pub. No.: US 2011/0193458 A1
(43) Pub. Date: Aug. 11, 2011

(54) RETAINING CLIP FOR AN ACTUATOR OF A FURNITURE FLAP

(76) Inventor: Christian OMANN, Hard (AT)

(21) Appl. No.: 13/091,449

(22) Filed: Apr. 21, 2011

Related U.S. Application Data
(63) Continuation of application No. PCT/AT2009/000349, filed on Sep. 7, 2009.

(30) Foreign Application Priority Data
Nov. 6, 2008 (AT) A 1726/2008

(51) Int. Cl. E05F 1/10; E05B 65/06; A47B 96/00

(52) U.S. Cl. 312/319.2; 49/386

(57) ABSTRACT

The invention relates to an actuator, comprising at least one pivotably supported actuating arm for moving a furniture flap, wherein the actuating arm is or can be acted on by a spring device, and wherein a retaining clip is proposed for the empty actuating arm on which no furniture flap is mounted yet, wherein the retaining clip prevents accidental opening or deflecting of the empty actuating arm and for this purpose comprises a brake or detent device which can be moved by a shaft (R), wherein a transmission gear is provided by which the pivot speed of the actuating arm can be geared to a higher rotational speed of the shaft (R) at least over a region of the pivot travel of the actuating arm in the open direction.

The present invention relates to an actuating device comprising at least one pivotably mounted actuating arm for moving a furniture flap, wherein the actuating arm is or can be acted upon by a spring device and wherein there is provided an assembly securing device for the vacant actuating arm on which therefore no furniture flap has yet been fitted, wherein the assembly securing device prevents accidental opening or deflection of the vacant actuating arm and for that purpose has a braking or latching device which can be moved by way of a shaft.

The invention further concerns an article of furniture having an actuating device of the kind to be described.

Such actuating devices serve for example to move a furniture flap which is connected to the pivotally mounted actuating arm between a vertical position in which a compartment in a carcass is covered and an upwardly moved open position. To compensate for the weight of the flap there is provided a spring device or a gas pressure storage means, wherein the torque acting on the actuating arm can be adjusted selectively to the weight of the flap to be moved. In the case of heavy furniture flaps therefore a very high torque is to be provided as the biasing force for the actuating arm. If now the actuating device is already pre-assembled to the article of furniture in the course of assembly but there is as yet no furniture flap pivotally connected to the actuating arm, there is the serious risk that the actuating arm can be massively deflected by the spring device acting thereon and as a result can seriously injure the assembly personnel. Therefore, WO 2006/069412 A1 to the present applicant already discloses an assembly securing device for the “vacant” actuating arm—to which therefore no furniture flap has yet been fitted—, which has a braking or latching device for limiting the opening speed of the vacant actuating arm.

It is an object of the present invention to propose an actuating device with an assembly securing device of the general kind set forth in the opening part of this specification, which prevents uncontrolled opening or deflection of the actuating arm even when very high biasing forces of the spring device are applied thereon.

In accordance with the invention in an advantageous configuration, that is achieved in that there is provided a step-up transmission by which the pivotal speed of the actuating arm—at least over a region of the pivot travel of the actuating arm in the opening direction—can be stepped up to a higher rotary speed of the shaft.

It is to be noted that the spring device acts on the actuating arm in the opening direction about an axis of rotation so that, when the flap is pivotably connected, a sufficiently high level of torque is provided for compensating for the weight of the flap. The higher the force of the spring device acting on the actuating arm, the correspondingly greater is the risk that the actuating arm deflects over a tolerable pivotal range when the flap is not pivotably connected thereto—even if there is provided a braking or latching device for preventing the actuating arm from kicking out. The arrangement of the step-up transmission can therefore reduce the reaction time of the braking or latching device as, upon an increase in the spring force (for example when fitting a spring device with increased standardized spring force), faster braking or stopping of the actuating arm also occurs.

The invention can be particularly advantageously implemented with braking or latching devices which comprise a centrifugal clutch for braking or stopping the actuating arm. More specifically the step-up transmission provides that a slight pivotal movement of the spring-loaded actuating arm already triggers a rotary movement of the shaft, which is increased by a defined ratio. Accordingly, when a predetermined pivotal speed of the actuating arm is exceeded, the braking or latching device also reacts substantially more quickly than in the case of conventional devices.

A further advantageous effect in terms of the arrangement of the step-up transmission is that the braking or latching device does not have to directly compensate for the acting enormous torque of the actuating arm. The step-up transmission provides that the holding moment occurring in the braking or latching device is also markedly reduced so that the unit formed by the braking or latching device can be smaller and possibly also less expensive. A braking or latching device of relatively small geometrical dimensions is of particular advantage by virtue of the very limited structural space in actuating devices.

An embodiment of the invention provides that the transmission ratio (i) of the step-up transmission is greater than 3, preferably greater than 5. That means for example that, in the case of a transmission ratio equal to 5, a pivotal movement of the actuating arm through 10° results in a rotary movement of the shaft (which is associated with the braking or latching device) through 50°. The desired higher transmission ratio is therefore determined by the ratio between the rotary speed of the shaft and the pivotal speed of the actuating arm.

Various options present themselves to the person skilled in the art for implementing the step-up transmission. In an embodiment it can be provided that the step-up transmission has a pinion gear transmission. In that respect a so-called internal gear pair has proven to be particularly advantageous, in which a pinion mounted to the shaft meshes with an internal tooth arrangement of a hollow gear or a tooth portion. The transmission ratio can be determined by the ratio of the diameter of the pinion to the diameter of the internal tooth arrangement. In that respect the length of the tooth portion can correspond approximately to the length of the pivotal range of the actuating arm.

Alternatively thereto however other design configurations are also possible for the gear transmission. Basically it is sufficient if the gear transmission has a first pinion meshing with at least one second pinion or a tooth arrangement of different size. In that connection it may be desirable if the first pinion is associated with the shaft and the second pinion or the tooth arrangement is associated with the housing of the actuating device. In that respect it can be provided that, during the pivotal movement of the actuating arm, the first pinion runs along a tooth arrangement which is preferably stationarily arranged on the housing of the actuating device. The step-up transmission can also embrace structures with a toothed belt or the like.

The centrifugal clutch provided for braking or stopping the actuating arm can have at least one movably mounted first clutch portion which is movable starting from a rest position (also against the force of a spring) into an outer position in which the first clutch portion can come into contact with a second clutch portion and can preferably be latched thereto. In that respect it is provided that under a predetermined pivotal speed of the actuating arm, the first clutch portion and the second clutch portion are uncoupled from each other and when a predetermined pivotal speed of the actuating arm is exceeded, the first clutch portion and the second clutch portion can come into contact with each other.

An embodiment of the invention provides at least two first clutch portions which can come into contact with a second clutch portion after the mass moment of inertia has been overcome (and possibly after a spring force has been overcome). The first clutch portions can have latching teeth (or latching recesses) or alternatively can also be provided with a friction lining. However, in the sense of immediately stopping the actuating arm, it may be desirable if the first clutch portion has at least one latching tooth which is latchable with at least one latching recess arranged or formed on the second clutch portion. It may also advantageous if the first clutch portion or portions has or have a plurality of latching teeth and the second clutch portion has a plurality of latching recesses.

An embodiment of the invention provides that the braking or latching device is arranged in or on a portion fixedly connected to the actuating arm and is also moved therewith. In that respect it may be desirable for the braking or latching device to be arranged on a rotatable control cam associated with the actuating arm.

The article of furniture according to the invention is characterized by at least one actuating drive of the described kind.

Further details and advantages of the invention will be apparent from the specific description hereinafter. In the drawing:

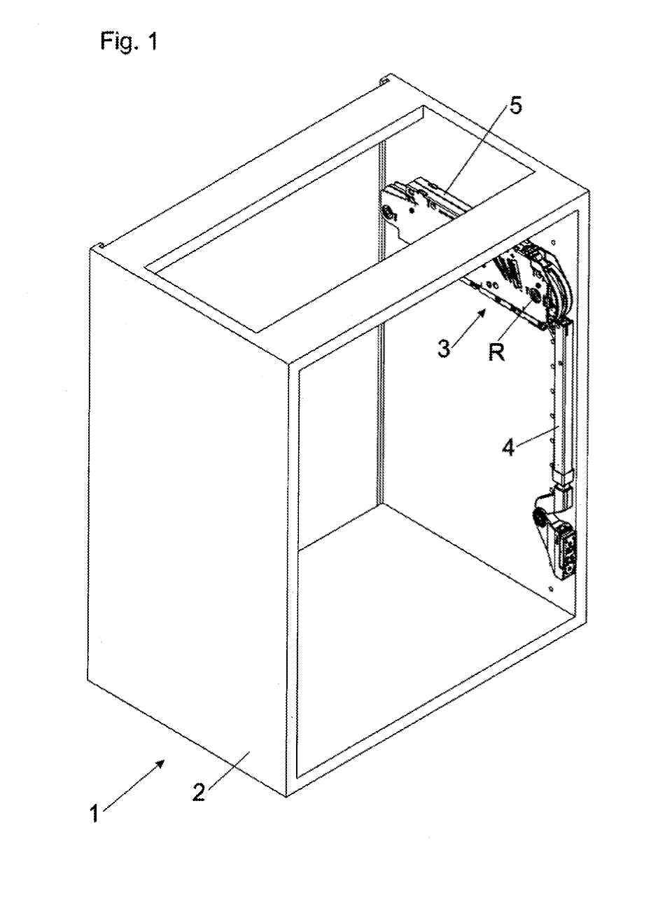

FIG. 1 shows a perspective view of an article of furniture in cabinet form with an actuating device, whereby the actuating arm thereof has not yet been fitted with a furniture flap,

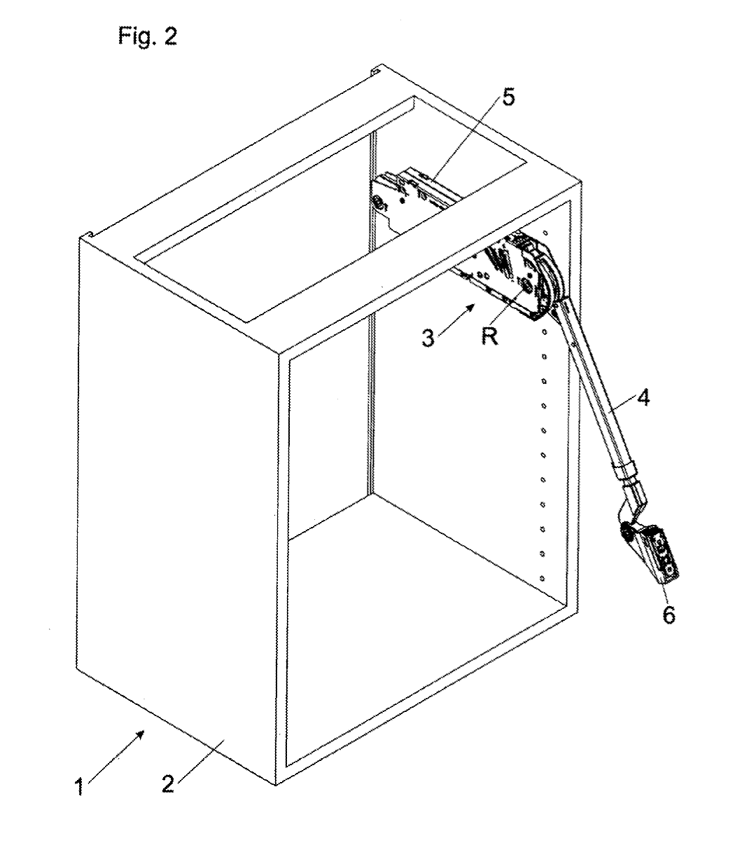

FIG. 2 shows the article of furniture of FIG. 1 with the actuating device whose actuating arm is arrested in an open position,

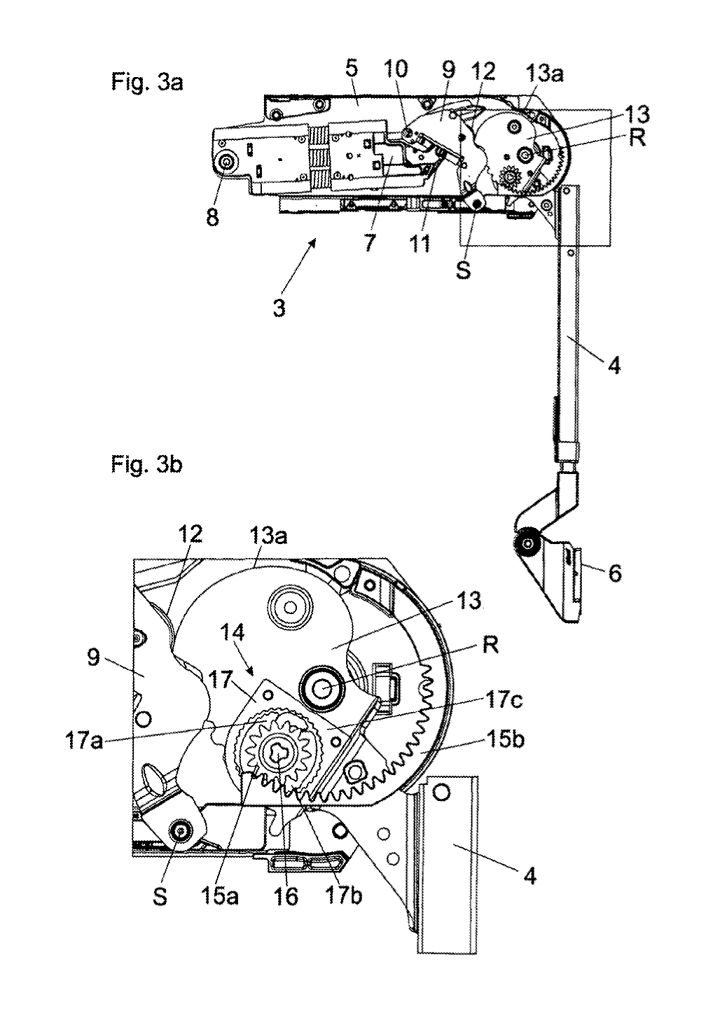

FIGS. 3a, 3b show a side view of an actuating device according to the invention in the unlatched condition and a detail view on an enlarged scale thereof,

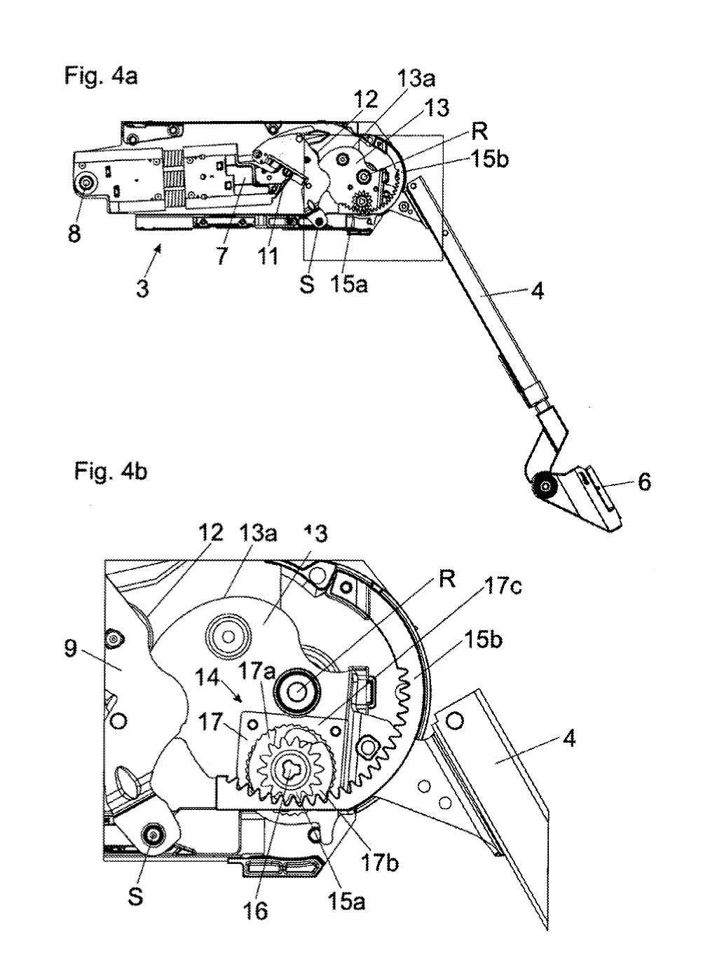

FIGS. 4a, 4b show a side view of an actuating device according to the invention in the latched condition and a detail view on an enlarged scale thereof,

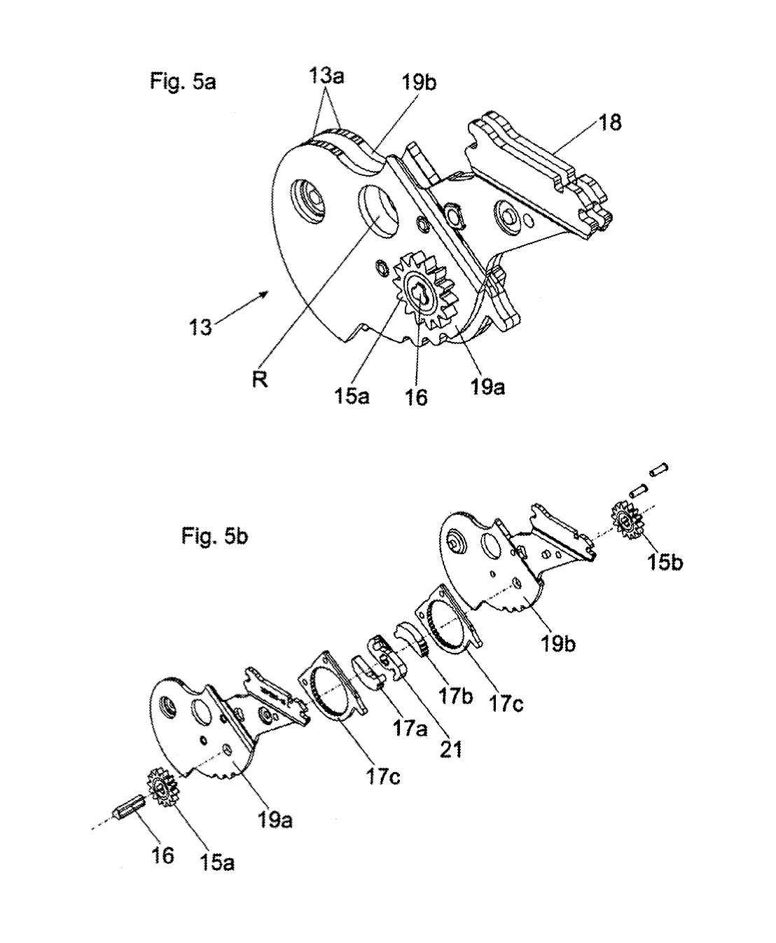

FIGS. 5a, 5b show the braking or latching device arranged on the control cam of the actuating arm and an exploded view thereof,

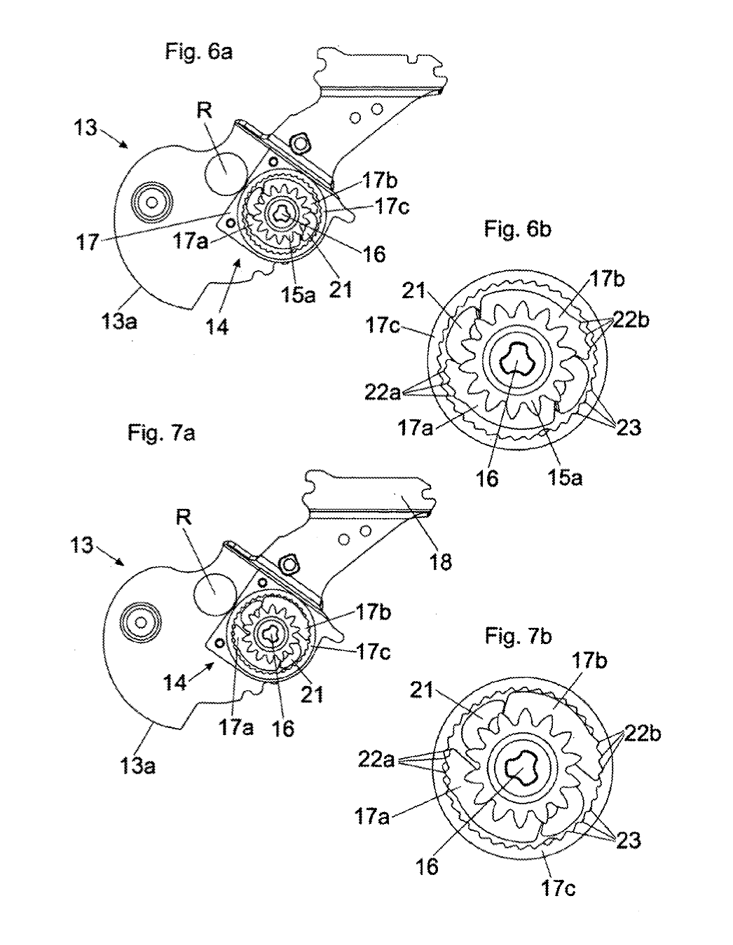

FIGS. 6a, 6b show a side view of the braking or latching device in the unlatched condition and a detail view on an enlarged scale thereof, and

FIGS. 7a, 7b show a side view of the braking or latching device in the latched condition and a detail view on an enlarged scale thereof.

FIG. 1 shows a perspective view of an article of furniture 1 in cabinet form in a typical assembly situation. An actuating device 3 according to the invention has been pre-assembled to the furniture carcass 2, the actuating device 3 has at least one actuating arm 4 for moving an upwardly movable furniture flap (not shown). The actuating arm 4 is mounted pivotably about an axis of rotation (R) between a closed position—as shown in the Figure—and an open position. The actuating arm 4 is or can be acted upon by a spring device arranged in the housing 5, the spring device urging the actuating arm 4 about the axis of rotation R in the direction of the open position. The spring device therefore serves for compensating for the weight of the flap, in which case the actuating arm 4 is biased with extremely high forces—depending on the respective weight of the flap which is still to be connected thereto. In the illustrated assembly situation in which therefore a flap has not yet been fitted, the actuating arm 4 can move uncontrolledly rapidly in the direction of the open position and in so doing cause serious injury.

FIG. 2 shows the arrangement of FIG. 1, wherein, after exceeding an admissible pivotal speed in the opening direction, the “vacant” actuating arm 4 is immediately arrested in its instantaneous pivotal position. The actuating arm 4 is adapted to be variable in length and has a connecting portion 6 latchable to a fitment portion associated with the furniture flap.

FIG. 3a shows a side view of the actuating device. It is possible to see a spring device 7 in the form of a spring pack which is supported on the one hand against a portion 8, which is fixed with respect to the article of furniture, on the housing 5, and which on the other hand acts on an intermediate lever 9 pivotal about axis of rotation S. An adjusting device 10 is provided to adjust the spring force acting on the actuating arm 4, whereby the position of the spring mounting 11 is variably adjustable relative to the axis of rotation S. Supported on the intermediate lever 9 is a pressure roller 12 which can run along a control contour 13a associated with the actuating arm 4 during the pivotal movement of the actuating arm 4 under the pressure of the spring device 7. The control contour 13a is formed by the peripheral edge of a control cam 13 rotatable about the axis of rotation (R), wherein the control cam 13 is or can be fixedly connected to the actuating arm 4.

FIG. 3b shows an enlarged view of the region identified in FIG. 3a. It shows the control cam 13 which is fixedly connected to the actuating arm 4 and which is pivotable about the axis of rotation R. An aspect of substantial significance is a braking or latching device 14 which is arranged at the rotatable control cam 13 and which, during the pivotal movement of the control cam 13, is also moved therewith. The braking or latching device 14 includes a gear transmission comprising a first pinion 15a arranged rotatably on a shaft 16, the shaft 16 being mounted rotatably at the control cam 13. During the pivotal movement of the actuating arm 4 the first pinion 15a runs along a tooth arrangement 15b arranged stationarily on the housing 5 of the actuating device 3. It will be seen that the tooth arrangement 15b is of a larger diameter than the diameter of the first pinion 15a, thereby affording the increased step-up ratio. More specifically if the radius of the tooth arrangement 15b is selected to be greater by the factor of 5 than the radius of the first pinion 15a, a pivotal movement of the actuating arm 4 through 10° leads to a rotary movement of the first pinion 15a, which is five times higher, whereby therefore the first pinion 15a is rotated through 50°. The braking or latching device 14 includes a centrifugal clutch 17 comprising two first clutch portions 17a and 17b which, when the actuating arm 4 exceeds a predetermined pivotal speed, are moved from an inner rest position in a radial direction into an outer position so that the two first clutch portions 17a and 17b latch with a second clutch portion 17c having an internal tooth arrangement. The two first clutch portions 17a and 17b are arranged behind the first pinion 15a and are mounted movably relative to the rotatable shaft 16. The first pinion 15a, with the tooth arrangement 15b, forms a so-called internal gear pair by way of the pivotal travel of the actuating arm 4, wherein the step-up transmission ratio can be defined by way of the radius of the first pinion 15a and the radius of the tooth arrangement 15b.

FIG. 4a and FIG. 4b show similar views to FIG. 3a and FIG. 3b with an actuating arm 4 which is further pivoted in the direction of the open position and which is arrested in its pivotal position by the braking or latching device 14. FIG. 4b shows an enlarged view of the region identified in FIG. 4a. The actuating arm 4 with its control cam 13 has been pivoted about the axis of rotation (R) from the closed position shown in FIG. 3b in the direction of the open position, in which case the control contour 13a of the control cam 13 runs on the pressure roller 12. In that pivotal movement of the actuating arm 4 the first pinion 15a can also run against the tooth arrangement 15b arranged stationarily on the housing 5, whereby the shaft 16 is also rotated by a defined multiple relative to the pivotal speed of the actuating arm 4. Below a predetermined pivotal speed of the actuating arm 4, the shaft 16 is moved, without the two first clutch portions 17a, 17b of the centrifugal clutch 17 latching with the tooth arrangement of the outer second clutch portion 17c, whereby the actuating arm 4 can also be moved unimpededly between the closed position and the open position. That is the case when a furniture flap is properly pivotably connected to the actuating arm 4 as the weight of the flap acts in opposition to the force of the spring device 7. If however no furniture flap is pivotally connected to the actuating arm 4 then, when an admissible pivotal speed is exceeded, the actuating arm 4 is immediately arrested in its instantaneous pivotal position by the braking or latching device 14 as both first clutch portions 17a and 17b are moved radially outwardly by the acting centrifugal force and are latched to the inner tooth arrangement of the outer second clutch portion 17c. The latching action can be released again by manually applying pressure to the actuating arm 4 in the direction of the closed position.

FIG. 5a shows the control cam 13 which is pivotally arranged about the axis of rotation R and which is latchable to the actuating arm 4 (not shown here) by way of a coupling portion 18. The control cam 13 has a control contour 13a which runs against the pressure roller 12 (FIG. 4b) during the pivotal movement of the control cam 13. The braking or latching device 14 is disposed between the two disks 19a and 19b of the control cam 13. It is possible to see the rotatable shaft 16, with the first pinion 15a mounted thereto. FIG. 5b shows an exploded view of the control cam 13. A respective first pinion 15a is arranged rotatably on the common shaft 16 at the outside of each of the two disks 19a and 19b. Arranged non-rotatably on the shaft 16 is a rotor 21 on which the two first clutch portions 17a and 17b are movably mounted. When the actuating arm 4 exceeds an admissible pivotal speed, the two first clutch portions 17a and 17b are latched to the tooth arrangement of the second clutch portion 17c so that the two first pinions 15a are blocked and cannot run any further on the tooth arrangement 17c (FIG. 4b) whereby the actuating arm 4 is also arrested in its instantaneous pivotal position.

FIG. 6a shows a side view of the braking or latching device 14 arranged on the control cam 13, wherein the first clutch portions 17a and 17b mounted movably to the rotor 21 are not latched to the outer tooth arrangement 17c. In that rest position of the two first clutch portions 17a and 17b, unimpeded movement of the control cam 13 (and therewith the actuating arm 4) about the axis of rotation R is possible so that the braking or latching device 14 does not influence the movement of a furniture flap which properly pivotably connected to the actuating arm 4.

FIG. 6b shows the braking or latching device 14 of FIG. 6a on an enlarged scale. It is possible to see the rest position of the two first clutch portions 17a and 17b, the tooth arrangements 22a and 22b of which are therefore not in engagement with the latching recesses 23 of the outer clutch portion 17c. Upon an opening movement of the actuating arm 4 the rotor 21 with the clutch portions 17a and 17b mounted movably thereto is rotated in the clockwise direction.

FIG. 7a shows in contrast the latched condition of the braking or latching device 14. A further particularity of the invention is to be mentioned in this context. It can be seen from FIG. 7a and the enlarged view in FIG. 7b that only one of the two first clutch portions 17a and 17b (namely only the clutch portion 17b) is fixedly latched to the outer second clutch portion 17c. The latching teeth 22a of the first clutch portion 17a are displaced relative to the latching teeth 22b of the other first clutch portion 17b approximately by half a tooth width relative to each other in such a way that upon latching engagement of the latching teeth 22b of the clutch portion 17b into the latching recesses 23 of the outer clutch portion 17c the latching teeth 22a of the clutch portion 17a just do not latch into the latching recesses 23 of the second clutch portion 17c. That situation is particularly clearly visible in FIG. 7b. In that way, in the event of the clutch portion 17b possibly rebounding, there is still the clutch portion 17b which is in a “waiting” position and which, when the actuating arm 4 exceeds the admissible pivotal speed, can latch to the latching recesses 23 of the second clutch portion 17c. It will be appreciated however that it is also possible that, when the actuating arm 4 exceeds an admissible pivotal speed, both clutch portions 17a and 17b are simultaneously latchable with the latching recesses 23 of the outer clutch portions 17c.

The present invention is not limited to the illustrated embodiment but includes or extends to all variants and technical equivalents which can fall within the scope of the claims appended hereto. The positional references adopted in the description such as for example up, down, lateral and so forth are also related to the usual installation position or to the Figure being directly described and illustrated and are to be appropriately transferred to the new position upon a change in position.

1. A device comprising an actuating device with at least one pivotally mounted actuating arm for moving a furniture flap, the actuating arm is acted upon by a spring device and wherein the actuating device further comprises an assembly securing device for the vacant actuating arm on which therefore no furniture flap has yet been fitted, wherein the assembly securing device prevents accidental opening or deflection of the vacant actuating arm and for that purpose has a braking or latching device movable by way of a shaft, the braking or latching device can be moved via a portion connected with the actuating arm about the shaft, wherein further provided is a step-up transmission by which the pivotal speed of the actuating arm at least over a region of the pivot travel of the actuating arm in the opening direction can be stepped up to a higher rotary speed of the shaft, wherein the step-up transmission comprises a gear transmission with a first pinion which meshes with a second pinion or with a tooth arrangement of different size, wherein the first pinion is arranged on the shaft and the second pinion or the tooth arrangement is arranged on the housing of the actuating device.

2. The actuating device according to claim 1, wherein the transmission ratio of the step-up transmission is greater than 3.

3. The actuating device according to claim 1, wherein the transmission ratio of the step-up transmission is greater than 5.

4. The actuating device according to claim 1, wherein the step-up transmission comprises an internal gear pair.

5. The actuating device according to claim 1, wherein the first pinion runs along the tooth arrangement during a pivotal movement of the actuating arm.

6. The actuating device according to claim 1, wherein the tooth arrangement is formed or arranged stationarily on the housing of the actuating device.

7. The actuating device according to claim 1, wherein the axis of rotation of the first pinion is arranged coaxially with the axis of rotation of the braking or latching device.

8. The actuating device according to claim 1, wherein the braking or latching device comprises a centrifugal clutch.

9. The actuating device according to claim 8, wherein the centrifugal clutch has at least one movably mounted first clutch portion which is movable starting from a rest position into an outer position in which the first clutch portion can be connected or latched to a second clutch portion.

10. The actuating device according to claim 9, wherein under a predetermined pivotal speed of the actuating arm the first clutch portion and the second clutch portion are uncoupled from each other and when a predetermined pivotal speed of the actuating arm is exceeded, the first clutch portion and the second clutch portion can be brought into contact with each other.

11. The actuating device according to claim 9, wherein the first clutch portion has at least one latching tooth latchable to at least one latching recess formed or arranged on the second clutch portion.

12. The actuating device according to claim 11, wherein the first clutch portion has a plurality of latching teeth and the second clutch portion has a plurality of latching recesses.

13. The actuating device according to claim 9, wherein there are provided at least two first clutch portions.

14. The actuating device according to claim 13, wherein the latching teeth of the one first clutch portion are arranged displaced relative to the latching teeth of the other first clutch portion through about half a tooth width relative to each other in such a way that upon latching engagement of the latching teeth of the one first clutch portion into the latching recesses of the second clutch portion the latching teeth of the other first clutch portion just do not latch into the latching recesses of the second clutch portion.

15. The actuating device according to claim 1, wherein the braking or latching device is arranged in or on a portion fixedly connected to the actuating arm and is moved therewith.

16. The actuating device according to claim 15, wherein the portion is formed or arranged on a rotatable control cam associated with the actuating arm.

17. An article of furniture comprising an actuating device according to claim 1.
